(19) United States
(12) Patent Application Publication
(10) Pub. No.: US 2015/0026104 A1
(43) Pub. Date: Jan. 22, 2015

(54) SYSTEM AND METHOD FOR EMAIL CLASSIFICATION

(71) Applicant: Christopher Tambos, Montclair, NJ (US)

(72) Inventor: Christopher Tambos, Montclair, NJ (US)

(21) Appl. No.: 14/334,624

(22) Filed: Jul. 17, 2014

Related U.S. Application Data
(60) Provisional application No. 61/847,191, filed on Jul. 17, 2013.

(51) Int. Cl. G06N 99/00; G06F 17/21; G06F 17/27; H04L 12/58; G06F 17/30

(52) U.S. Cl. CPC G06N 99/005; H04L 51/04; G06F 17/30386; G06F 17/2735; G06F 17/218
USPC 706/12

(57) ABSTRACT

The present invention generally relates to an improved system and method for providing email classification. Specifically, the present invention relates to an email classification system and method for analyzing the signature of an email for proper classification.

### CROSS REFERENCE TO RELATED APPLICATIONS

This application claims the benefit of U.S. Provisional Patent Application No. 61/847,191 filed Jul. 17, 2013 and entitled “SYSTEM AND METHOD FOR EMAIL CLASSIFICATION”, the entire disclosure of which is incorporated herein by reference.

### FIELD OF THE INVENTION

The present invention generally relates to an improved system and method for providing email classification. Specifically, the present invention relates to an email classification system and method for analyzing the signature of an email for proper classification.

### BACKGROUND OF THE INVENTION

Email is a ubiquitous form of communication currently in use in all spectrums of life. With email being such a massive form of communication, one issue that has arisen is that important emails can easily be lost in a sea of unimportant or unsolicited email communications.

As individuals become reliant on email to communicate for every purpose, from work to family and everything in between, individual email boxes may become cluttered with all types of communications. While some individuals attempt to sort these emails manually by category, sender or other commonality, the process is painstaking and time consuming.

Some email systems provide for classification based on certain criteria, such as sender's email address, domain the email was sent from, or keyword finders. However, these simplistic systems are generally rigid rule based systems that lead to significant false positives and moving of emails to the wrong place unintentionally.

Therefore, there is a need in the art for a system and method for processing and classifying emails that reduces the potential for false positives causing misclassification of the emails. These and other features and advantages of the present invention will be explained and will become obvious to one skilled in the art through the summary of the invention that follows.

### SUMMARY OF THE INVENTION

Accordingly, it is an object of the present invention to provide a system and method for processing and classifying emails. The system and method described herein reduces the potential for false positives and misclassification of emails.

According to an embodiment of the present invention, a system for providing email classification includes: an email processing module, comprising computer-executable code stored in non-volatile memory, a machine learning module, comprising computer-executable code stored in non-volatile memory, a processor, and a communications means, wherein said email processing module, said machine learning module, said processor, and said communications means are operably connected and are configured to: receive an email; remove hypertext markup language (HTML) from said email; remove extra white space, and tabs from said email; convert all text contained in said email to lowercase characters; compare text to relationship terms stored in a relationship term database; tag text matching one or more of said relationship terms; tag text comprising dates, numbers, indicators of time, measurement units, and currency symbols; tag text comprising parts of speech; compare text to lemmatize terms stored in a lemmatize dictionary database; tag text matching one or more lemmatize terms; remove non-essential punctuation from said text; calculate and weigh term frequency in said text using term frequency inverse document frequency; eliminate one or more terms with the lowest calculated weight; and classify said email based on remaining tags and terms.

According to an embodiment of the present invention, the classification of said email is accomplished via a Naive Bayes classifier process. However this technique can be used with other classifiers based on decision tree (and random forest) and KNN and SVM (discussed below).

According to an embodiment of the present invention, the system further comprises a Naïve Bayes Trainer module and a NaïBayes classifier module.

According to an embodiment of the present invention, the classification of said email is accomplished via a Support Vector Machines (SVM) or Support Vector Networks (SVN) classifier process.

According to an embodiment of the present invention, the system further comprises one or more of a Support Vector Machine trainer module, a Support Vector Network trainer module, a Support Vector Machine classifier module, and a Support Vector Network classifier module.

According to an embodiment of the present invention, the email processing module, said machine learning module, said processor, and said communications means are further configured to match remaining terms with categories stored in a category database.

According to an embodiment of the present invention, the email processing module, said machine learning module, said processor, and said communications means are further configured to replace one or more remaining terms with replacement tags.

According to an embodiment of the present invention, the email processing module, said machine learning module, said processor, and said communications means are further configured to move said email to a location based on said replacement tags.

According to an embodiment of the present invention, the email processing module, said machine learning module, said processor, and said communications means are further configured to replace one or more remaining terms with replacement categories.

According to an embodiment of the present invention, the email processing module, said machine learning module, said processor, and said communications means are further configured to move said email to a location based on said replacement categories.

According to an embodiment of the present invention, a method for classifying emails includes the steps of: receiving an email at an email processing module, comprising computer-executable code stored in non-volatile memory; removing hypertext markup language (HTML) from said email; removing multiple white space, and tabs from said email; converting all text contained in said email to lowercase characters; comparing text to relationship terms stored in a relationship term database; tagging text matching one or more of said relationship terms; tagging text comprising dates, numbers, indicators of time, measurement units, and currency symbols; tagging text comprising parts of speech; comparing text to lemmatize terms stored in a lemmatize dictionary database; tagging text matching one or more lemmatize terms; removing non-essential punctuation from said text; calculating and weigh term frequency in said text using term frequency inverse document frequency; eliminating one or more terms with the lowest calculated weight; and classifying said email based on remaining tags and terms.

According to an embodiment of the present invention, the method further includes the step of matching remaining terms with categories stored in a category database.

According to an embodiment of the present invention, the method further includes the step of replacing one or more remaining terms with replacement tags.

According to an embodiment of the present invention, the method further includes the step of moving said email to a location based on said replacement tags.

According to an embodiment of the present invention, the method further includes the step of replacing one or more remaining terms with replacement categories.

According to an embodiment of the present invention, the method further includes the step of moving said email to a location based on said replacement categories.

The foregoing summary of the present invention with the preferred embodiments should not be construed to limit the scope of the invention. It should be understood and obvious to one skilled in the art that the embodiments of the invention thus described may be further modified without departing from the spirit and scope of the invention.

### BRIEF DESCRIPTION OF THE DRAWINGS

FIG. 1 illustrates a schematic overview of a computing device, in accordance with an embodiment of the present invention;

FIG. 2 illustrates a network schematic of a system, in accordance with an embodiment of the present invention;

FIG. 3A illustrates a schematic of a system for providing improved email classification, in accordance with an embodiment of the present invention;

FIG. 3B illustrates a schematic of a system for providing improved email classification, in accordance with an embodiment of the present invention;

FIGS. 4A, 4B and 4C collectively form an exemplary process flow for an email classification system, in accordance with an embodiment of the present invention; and

FIGS. 5A and 5B show examples of transformation of text/data in accordance with an exemplary process conducted by an embodiment of the present invention.

### DETAILED SPECIFICATION

The present invention generally relates to an improved system and method for providing email classification. Specifically, the present invention relates to an email classification system and method for analyzing the signature of an email for proper classification.

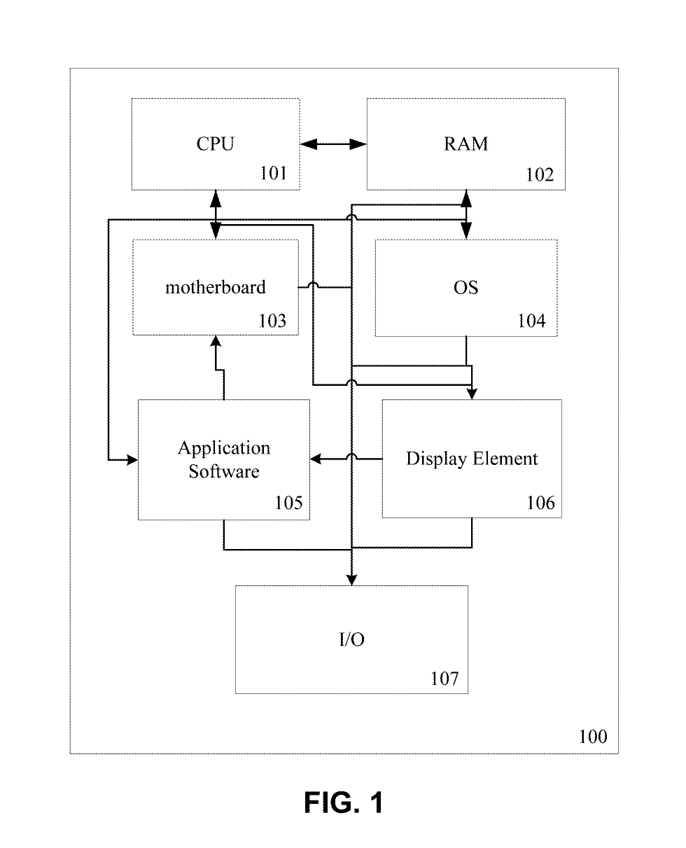

According to an embodiment of the present invention, the system and method is accomplished through the use of one or more computing devices. As shown in FIG. 1, One of ordinary skill in the art would appreciate that a computing device 100 appropriate for use with embodiments of the present application may generally be comprised of one or more of a Central processing Unit (CPU) 101, Random Access Memory (RAM) 102, a storage medium (e.g., hard disk drive, solid state drive, flash memory, cloud storage) 103, an operating system (OS) 104, one or more application software 105, a display element 106 and one or more input/output devices/means 107. Examples of computing devices usable with embodiments of the present invention include, but are not limited to, personal computers, smartphones, laptops, mobile computing devices, tablet PCs and servers. The term computing device may also describe two or more computing devices communicatively linked in a manner as to distribute and share one or more resources, such as clustered computing devices and server banks/farms. One of ordinary skill in the art would understand that any number of computing devices could be used, and embodiments of the present invention are contemplated for use with any computing device.

In an exemplary embodiment according to the present invention, data may be provided to the system, stored by the system and provided by the system to users of the system across local area networks (LANs) (e.g., office networks, home networks) or wide area networks (WANs) (e.g., the Internet). In accordance with the previous embodiment, the system may be comprised of numerous servers communicatively connected across one or more LANs and/or WANs. One of ordinary skill in the art would appreciate that there are numerous manners in which the system could be configured and embodiments of the present invention are contemplated for use with any configuration.

In general, the system and methods provided herein may be consumed by a user of a computing device whether connected to a network or not. According to an embodiment of the present invention, some of the applications of the present invention may not be accessible when not connected to a network, however a user may be able to compose data offline that will be consumed by the system when the user is later connected to a network.

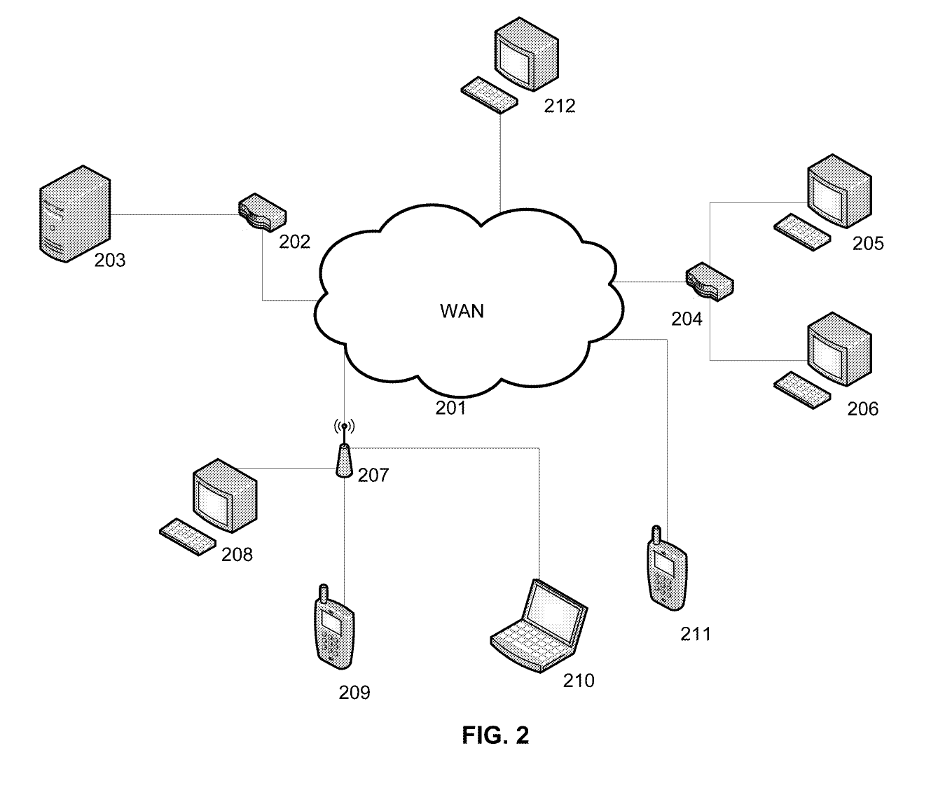

Referring to FIG. 2, a schematic overview of a system in accordance with an embodiment of the present invention is shown. The system is comprised of one or more application servers 203 for electronically storing information used by the system. Applications in the server 203 may retrieve and manipulate information in storage devices and exchange information through a WAN 201 (e.g., the Internet). Applications in server 203 may also be used to manipulate information stored remotely and process and analyze data stored remotely across a WAN 201 (e.g., the Internet).

According to an exemplary embodiment, as shown in FIG. 2, exchange of information through the WAN 201 or other network may occur through one or more high speed connections. In some cases, high speed connections may be over-the-air (OTA), passed through networked systems, directly connected to one or more WANs 201 or directed through one or more routers 202. Router(s) 202 are completely optional and other embodiments in accordance with the present invention may or may not utilize one or more routers 202. One of ordinary skill in the art would appreciate that there are numerous ways server 203 may connect to WAN 201 for the exchange of information, and embodiments of the present invention are contemplated for use with any method for connecting to networks for the purpose of exchanging information. Further, while this application refers to high speed connections, embodiments of the present invention may be utilized with connections of any speed.

Components of the system may connect to server 203 via WAN 201 or other network in numerous ways. For instance, a component may connect to the system i) through a computing device 212 directly connected to the WAN 201, ii) through a computing device 205, 206 connected to the WAN 201 through a routing device 204, iii) through a computing device 208, 209, 210 connected to a wireless access point 207 or iv) through a computing device 211 via a wireless connection (e.g., CDMA, GMS, 3G, 4G) to the WAN 201. One of ordinary skill in the art would appreciate that there are numerous ways that a component may connect to server 203 via WAN 201 or other network, and embodiments of the present invention are contemplated for use with any method for connecting to server 203 via WAN 201 or other network. Furthermore, server 203 could be comprised of a personal computing device, such as a smartphone, acting as a host for other computing devices to connect to.

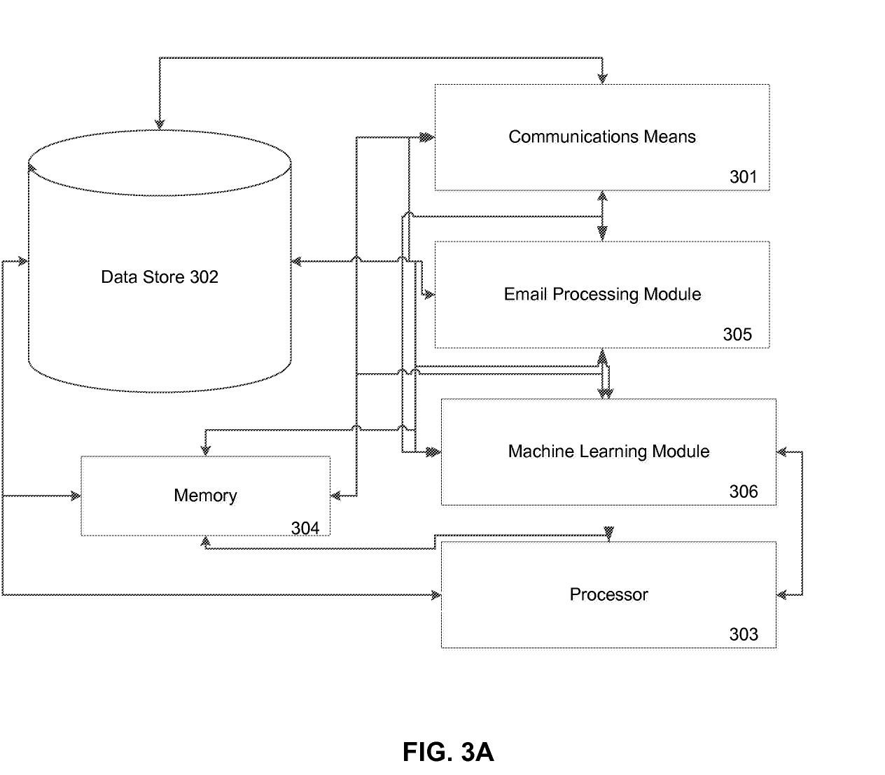

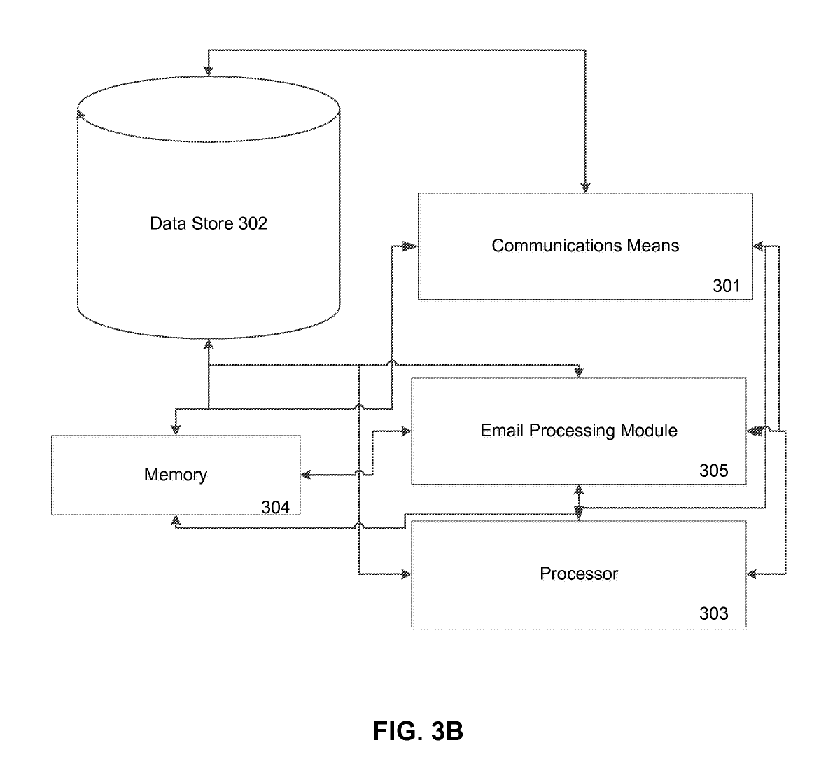

Turning to FIG. 3A, according to an embodiment of the present invention, a system for providing improved email classification is comprised of one or more communications means 301, one or more data stores 302, a processor 303, memory 304, an email processing module 305 and a machine learning module 306. In FIG. 3B, according to an embodiment of the present invention, a system for providing improved email classification is comprised of one or more communications means 301, one or more data stores 302, a processor 303, memory 304 and an email processing module 305. One of ordinary skill in the art would appreciate that the system may be operable with a number of optional components, and embodiments of the present invention are contemplated for use with any such optional component.

According to an embodiment of the present invention, the communications means of the system may be, for instance, any means for communicating data, voice or video communications over one or more networks or to one or more peripheral devices attached to the system. Appropriate communications means may include, but are not limited to, wireless connections, wired connections, cellular connections, data port connections, Bluetooth connections, or any combination thereof. One of ordinary skill in the art would appreciate that there are numerous communications means that may be utilized with embodiments of the present invention, and embodiments of the present invention are contemplated for use with any communications means.

Embodiments of the present invention are configured to improve email classification by analyzing a signature of an email and tagging associated data using a hierarchy of data from a data store (e.g., database) before sending the email for processing by a machine learning algorithm. The advantages of this process are that the system generalizes the data, allowing the machine learning process to find more common features than would otherwise be possible. In addition the added tag list is optimized to include only the most relevant items with the use of Term Frequency Inverse Document Frequency (TFIDF). The combination of these two techniques leaves unique tags behind that provide a far higher likelihood of accurate classification with less data.

According to an embodiment of the present invention, the invention may be useful to those that wish to classify email in a more effective way, allowing for the grouping of data into categories, particularly in the business context. This method allows machine learning systems to generalize data in an intelligent way in order to find similarities more easily among smaller sets of data.

Exemplary Embodiment

According to an embodiment of the present invention, the system utilizes a training process that begins with email that is previously classified (e.g., via a user's input). Those emails are fed through the training processes one by one to provide the classifier with the information it needs to classify new individual email that need to be classified.

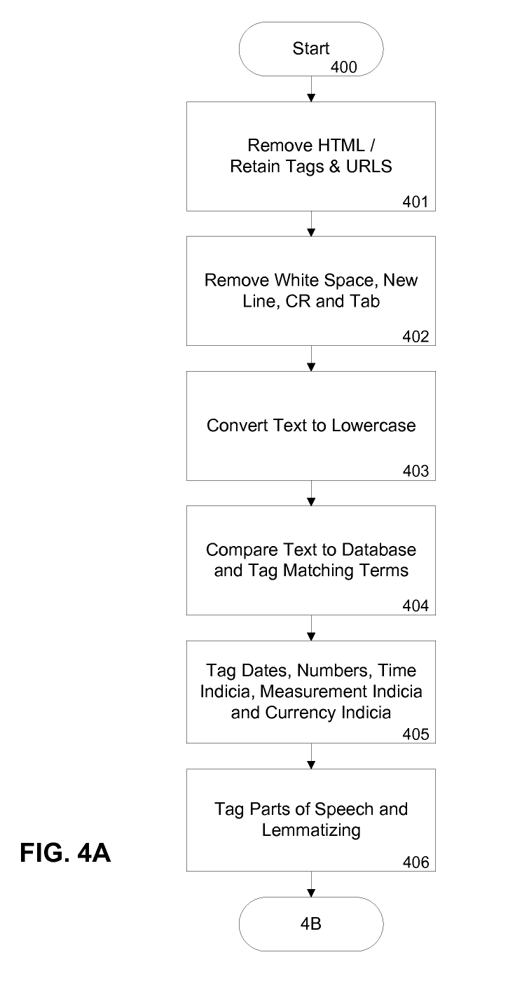

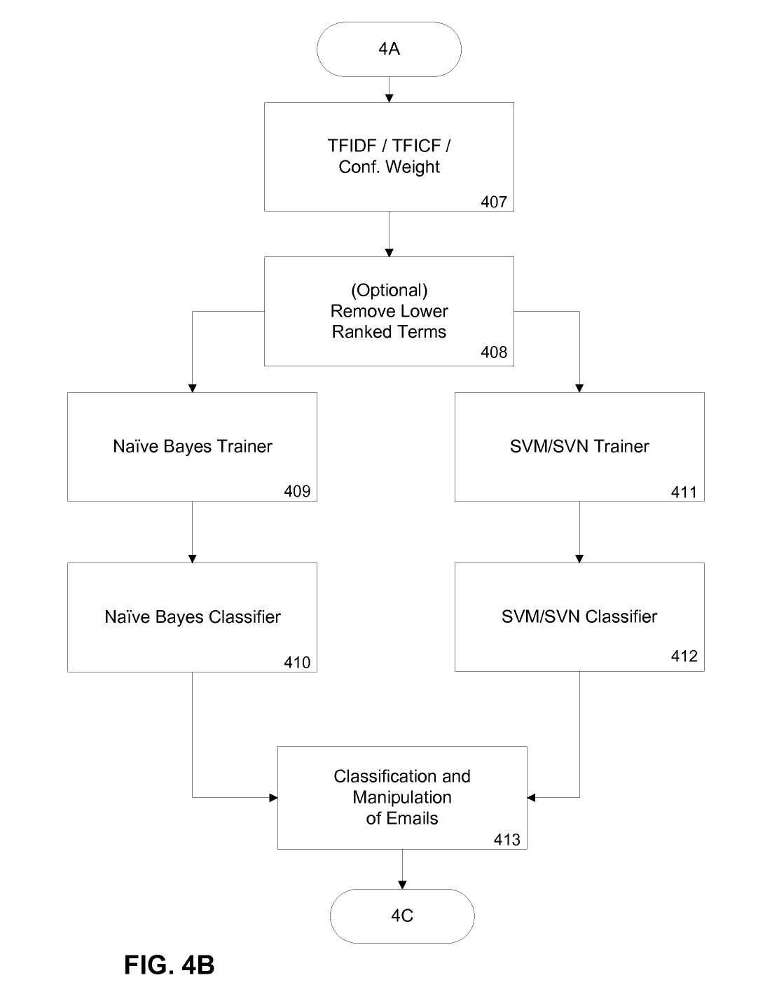

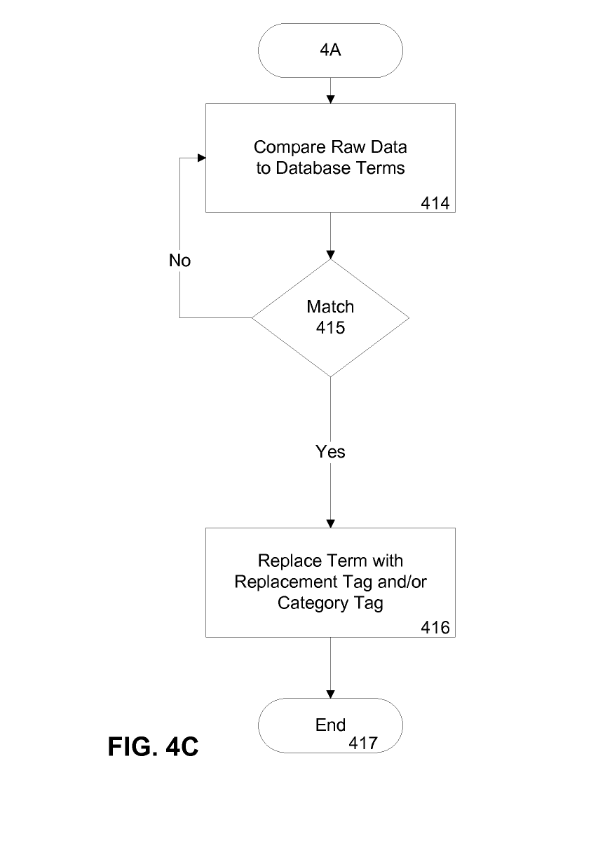

Turning now to FIG. 4A, a portion of an exemplary process flow for an email classification system, in accordance with an embodiment of the present invention, is shown. According to this embodiment of the present invention, emails begins to go through the pre-processing tasks, which include, but are not limited to: i) Removal of html or any markup (step 401), ii) Removal of white space except for single spaces between terms (step 402), and iii) Conversion of all text to small letters (step 403). One of ordinary skill in the art would appreciate that the pre-processing tasks could be completed in fewer or greater number of steps or portions of the pre-processing task shown here could be made optional or removed from use. One of ordinary skill in the art would appreciate that additional pre-processing steps could be used (e.g., remove attachments) in certain embodiments.

According to an embodiment of the present invention, after the pre-processing tasks are completed, the document is compared with a data store (e.g., database, dictionary file, file store) of terms that are organized into a taxonomy of hierarchical information (step 404). This taxonomy can also be replaced with a faceted classification model for a more complete list of tags. If a term or combination of terms is found in the data store, the term is replaced with appropriate tags.

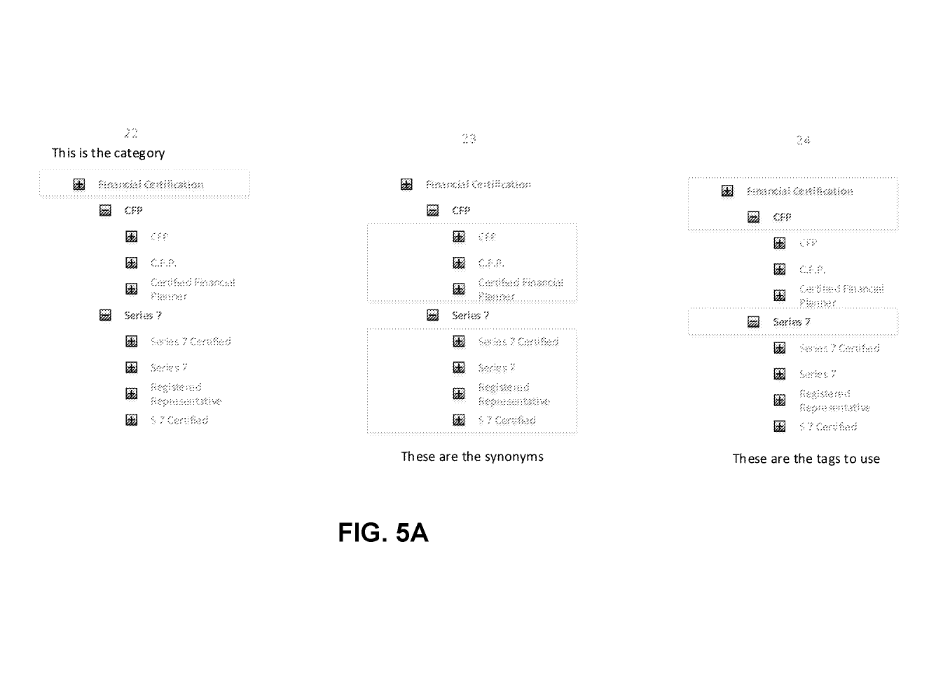

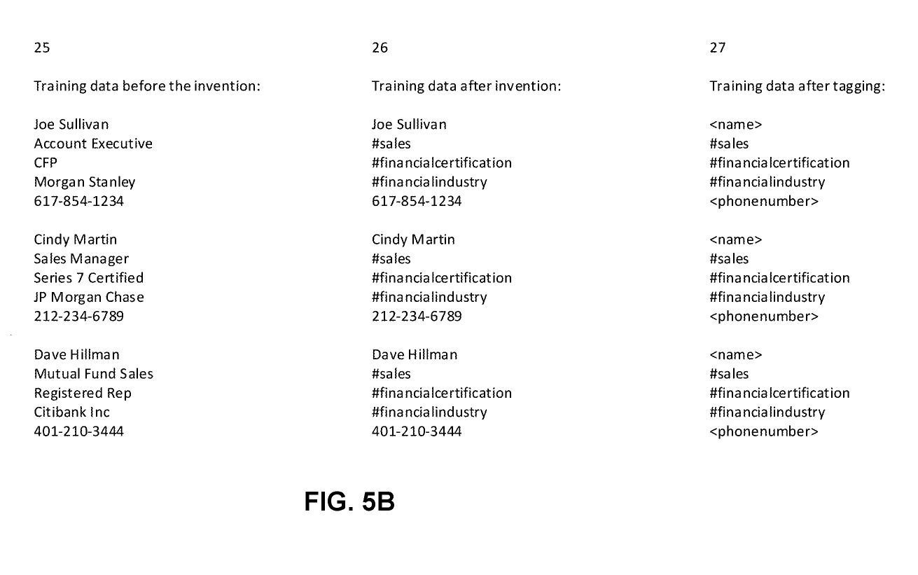

Turning now to FIG. 5A, according to an embodiment of the present invention, the matching process includes the usage of synonyms for the terms so that similar terms or formats of a term are found and standardized (23). The standardized term replaces the source term as the first tag (24). In certain embodiments, one or more of the parents of the tag which is up one or more levels in the hierarchy may also be added to the tags in the email data (22). It is optional to use multiple tags if the user wishes to use faceted classification; however, doing so gives more weight to the term as each added tag increases the weight of that particular term.

Returning now to FIG. 4A, according to an embodiment of the present invention, pre-processing is continued. At this point, the system tags all dates, time indicia, numbers, measurement indicia, currency indicia, other specifics, or any combination thereof (step 405). Next, the system performs a lemmatization, where the document is i) analyzed by a “Part of Speech” (POS) tagger, ii) lemmatized using the POS, and iii) the POS tags are removed. Last, all extraneous punctuation is removed (step 406).

Turning now to FIG. 4B, continuing according to an embodiment of the present invention, a TFILF process is used to calculate term frequency (step 407). In a preferred embodiment, the TFILF process finds the term frequency in the document and gives higher weighting to terms that are within one category and lower weighting to terms that are in multiple categories. The goal is to find the term weighting so that a Naive Bayes or other machine learning process can more effectively calculate the probability that a document falls into a category. There are several ways to calculate this. Examples of such exemplary methods are detailed below:

TFIDF—Term Frequency Inverse Document Frequency. This is the basic T F I DF weighting method, the formula is as below:

$$IDF = log ( \frac{N}{df ( {t}_{i} )} )$$

Where N refers to the number of all documents, and d_{f}(tᵢ) refers to the number of documents containing term tᵢ.

ConfWeight. The weighting method (named ConfWeight) is based on statistical confidence intervals. Let xₜ be the number of documents containing the word t in a text collection and n be the size of this text collection. The estimate for the proportion of documents containing this term is:

$$\hat{p} = \frac{{x}_{t} + 0.5 {z}_{α \text{/} 2}^{2}}{n + {z}_{α \text{/} 2}^{2}} \qquad ( 1 )$$

Where \hat{p} is the Wilson proportion estimate and z_{a/2}² is a value such that Φ(z_{a/2})=a/2, Φ is the t-distribution (Student's law) function when n<30 and the normal distribution one when n is greater than or equal to 30. So when n is greater than or equal to 30², \hat{p} is:

$$\hat{p} = \frac{{x}_{t} + 1.96}{n + 3.84} \qquad ( 2 )$$

Thus, its confidence interval at 95% is:

$$\hat{p} \pm 1.96 \sqrt{\frac{\hat{p} ( 1 - \hat{p} )}{n + 3.84}} \qquad ( 3 )$$

For a given category, \hat{p}+, the equation (2) applied to the positive documents (those who are labled as being related to the category) in the training set and \hat{p}, to those in the negative class. The label MinPos is used for the lower range of confidence interval of \hat{p}+, and the label MaxNeg for the higher range of that \hat{p}, according to (3) measured on their respective training set. Now, let MinPosRefFreq be:

$$MinPosRelFreq = \frac{MinPos}{MinPos + MaxNeg} \qquad ( 4 )$$

The strength of term t for category + is defined as:

str_{t,+}=log₂(2MinPosRelFreq) if MinPos>MaxNeg

Otherwise, the value would be zero. The maximum strength oft is named as:

maxstr(t)=(max(str_{t,c}))²

Finally, the ConfWeight of t in a document d is defined as:

ConfWeight_{t,d}=log(tf_{t,d}+1)maxstr(t) (5)

ConfWeight is similar to TFIDF. However, unlike TFIDF, ConfWeight uses the categorization problem to determine the weight of a particular term.

IDF*ICF. Inverse Document Frequency Inverse Category Frequency (IDFICF). This method is the combination of IDF and ICF, and an exemplary formula is below:

wᵢ=tf(tᵢ)*idf(tᵢ)*icf(tᵢ)

Where tf(tᵢ) refers to the term frequency of tᵢ, idf(tᵢ) refers to the inverse document frequency of tᵢ, icf(tᵢ) refers to the icf-based weight of tᵢ.

IDF*ICF̂2. Inverse Document Frequency Inverse Category Frequency Squared. This method is also a combination of IDF and ICF, similar but not the same to the above method. The formula is below:

wᵢ=tf(tᵢ)*idf(tᵢ)*icf(tᵢ)²

Where tf(tᵢ) refers to the term frequency of tᵢ, idf(tᵢ) refers to the inverse document frequency of tᵢ, icf(tᵢ) refers to the icf-based weight of tᵢ.

While the above referenced formula and methods for determining term frequency and weighing terms and categories, one of ordinary skill in the art would appreciate that there are numerous methods that could be utilized for such determinations. Embodiments of the present invention are contemplated for use with any such method for determining term frequency and weighing of terms and categories.

The determination of term frequency and weighing of terms is important because some of the tags that are added in previous pre-processing steps will need to be deprecated due to the repetitive nature in numerous categories. This process will give those repetitive/duplicative terms/tags a far lower ranking than non-repetitive/non-duplicative terms/tags. This leaves the common tags to identify the category.

Continuing, information gained via the process is used to remove the lower ranking terms (step 408). According to a preferred embodiment, this step is optional and should be carefully considered as this could remove terms that are relevant even if they are only in a small number of documents.

The machine learning process begins once the pre-processing is completed. The data from the pre-processing process is fed to the machine learning process of choice. According to a preferred embodiment, Naive Bayes and Support Vector Machines (SVM) (also Support Vector Networks (SVN)) are among the best choices; however the selection of the specific machine learning process is up to the user.

With respect to the exemplary method shown in FIG. 4B, the process may step to a NaïBayes trainer (step 409) or a SVM/SVN Trainer (step 411). At this point, the training process concludes and the classification process begins (NaïBayes classification at step 410 or SVM/SVN classification at step 413) with the model data being output from the training process and being communicated to the classifier for use in classifying new incoming data.

At step 412, the system classifies and manipulates the emails according to the classifications received in the previous steps.

Turning now to FIG. 4C, according to an embodiment of the present invention, the same processes will be used for individual emails that need to be categorized as those that were utilized during the training process. As a document comes into the system it is first preprocessed and the data is fed to a classifier process (step 413) that uses the model output from the preceding process and classifies that document to match terms (step 414) stored in a term database. Matched terms are replaced with replacement tags and/or categories for use in classifying the email (step 415).

After the classification process is concluded, the process is terminated or made available for processing of additional or pending/waiting emails (step 416). The classification process can be run as a background process, as a “just-in-time” process, or at any point in between. One of ordinary skill in the art would appreciate that there are numerous timings and scheduling means that could be utilized with embodiments of the present invention, and the selection of the appropriate means may depend on system purpose and utilization characteristics (e.g., processing may be done as emails come in or if emails are received in batches, they can be processed when system utilization is low).

According to an embodiment of the present invention, a business user may be using an email classification application to help manage their heavy load of email on a daily basis. As an illustrative example, embodiments of the system will allow that user to more accurately and quickly train the system to classify their information. For example if the user has three emails with different signatures from different people in their inbox (25) and a productivity tool is being used to group that information, the system needs a way to find similarities. Once the emails are processed by this system the data goes from no similarities (26) to three similarities. Then when the information is further processed (optional) the names can be tagged and the phone number can be tagged and note that these 3 email signatures are identical (27). This makes sense because these three emails are from a person that is in the financial industry, has a financial certification and is in sales. If the user wishes to maintain the identity of the sender to group by sender this can be done by not tagging the name, this is optional.

Even though the document focuses on emails as a particular type of textual document that could be classified and analyzed under the described functionality, one of ordinary skill in the art would appreciate that system and methods described herein could be utilized in conjunction with the classification and processing of any document. Accordingly, embodiments of the system and methods described herein could be utilized in conjunction with the classification and analysis of any type of document.

Throughout this disclosure and elsewhere, block diagrams and flowchart illustrations depict methods, apparatuses (i.e., systems), and computer program products. Each element of the block diagrams and flowchart illustrations, as well as each respective combination of elements in the block diagrams and flowchart illustrations, illustrates a function of the methods, apparatuses, and computer program products. Any and all such functions (“depicted functions”) can be implemented by computer program instructions; by special-purpose, hardware-based computer systems; by combinations of special purpose hardware and computer instructions; by combinations of general purpose hardware and computer instructions; and so on—any and all of which may be generally referred to herein as a “circuit,” “module,” or “system.”

While the foregoing drawings and description set forth functional aspects of the disclosed systems, no particular arrangement of software for implementing these functional aspects should be inferred from these descriptions unless explicitly stated or otherwise clear from the context.

Each element in flowchart illustrations may depict a step, or group of steps, of a computer-implemented method. Further, each step may contain one or more sub-steps. For the purpose of illustration, these steps (as well as any and all other steps identified and described above) are presented in order. It will be understood that an embodiment can contain an alternate order of the steps adapted to a particular application of a technique disclosed herein. All such variations and modifications are intended to fall within the scope of this disclosure. The depiction and description of steps in any particular order is not intended to exclude embodiments having the steps in a different order, unless required by a particular application, explicitly stated, or otherwise clear from the context.

Traditionally, a computer program consists of a finite sequence of computational instructions or program instructions. It will be appreciated that a programmable apparatus (i.e., computing device) can receive such a computer program and, by processing the computational instructions thereof, produce a further technical effect.

A programmable apparatus includes one or more microprocessors, microcontrollers, embedded microcontrollers, programmable digital signal processors, programmable devices, programmable gate arrays, programmable array logic, memory devices, application specific integrated circuits, or the like, which can be suitably employed or configured to process computer program instructions, execute computer logic, store computer data, and so on. Throughout this disclosure and elsewhere a computer can include any and all suitable combinations of at least one general purpose computer, special-purpose computer, programmable data processing apparatus, processor, processor architecture, and so on.

It will be understood that a computer can include a computer-readable storage medium and that this medium may be internal or external, removable and replaceable, or fixed. It will also be understood that a computer can include a Basic Input/Output System (BIOS), firmware, an operating system, a database, or the like that can include, interface with, or support the software and hardware described herein.

Embodiments of the system as described herein are not limited to applications involving conventional computer programs or programmable apparatuses that run them. It is contemplated, for example, that embodiments of the invention as claimed herein could include an optical computer, quantum computer, analog computer, or the like.

Regardless of the type of computer program or computer involved, a computer program can be loaded onto a computer to produce a particular machine that can perform any and all of the depicted functions. This particular machine provides a means for carrying out any and all of the depicted functions.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Computer program instructions can be stored in a computer-readable memory capable of directing a computer or other programmable data processing apparatus to function in a particular manner. The instructions stored in the computer-readable memory constitute an article of manufacture including computer-readable instructions for implementing any and all of the depicted functions.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

The elements depicted in flowchart illustrations and block diagrams throughout the figures imply logical boundaries between the elements. However, according to software or hardware engineering practices, the depicted elements and the functions thereof may be implemented as parts of a monolithic software structure, as standalone software modules, or as modules that employ external routines, code, services, and so forth, or any combination of these. All such implementations are within the scope of the present disclosure.

In view of the foregoing, it will now be appreciated that elements of the block diagrams and flowchart illustrations support combinations of means for performing the specified functions, combinations of steps for performing the specified functions, program instruction means for performing the specified functions, and so on.

It will be appreciated that computer program instructions may include computer executable code. A variety of languages for expressing computer program instructions are possible, including without limitation C, C++, Java, JavaScript, assembly language, Lisp, and so on. Such languages may include assembly languages, hardware description languages, database programming languages, functional programming languages, imperative programming languages, and so on. In some embodiments, computer program instructions can be stored, compiled, or interpreted to run on a computer, a programmable data processing apparatus, a heterogeneous combination of processors or processor architectures, and so on.

In some embodiments, a computer enables execution of computer program instructions including multiple programs or threads. The multiple programs or threads may be processed more or less simultaneously to enhance utilization of the processor and to facilitate substantially simultaneous functions. By way of implementation, any and all methods, program codes, program instructions, and the like described herein may be implemented in one or more thread. The thread can spawn other threads, which can themselves have assigned priorities associated with them. In some embodiments, a computer can process these threads based on priority or any other order based on instructions provided in the program code.

Unless explicitly stated or otherwise clear from the context, the verbs “execute” and “process” are used interchangeably to indicate execute, process, interpret, compile, assemble, link, load, any and all combinations of the foregoing, or the like. Therefore, embodiments that execute or process computer program instructions, computer-executable code, or the like can suitably act upon the instructions or code in any and all of the ways just described.

The functions and operations presented herein are not inherently related to any particular computer or other apparatus. Various general-purpose systems may also be used with programs in accordance with the teachings herein, or it may prove convenient to construct more specialized apparatus to perform the required method steps. The required structure for a variety of these systems will be apparent to those of skill in the art, along with equivalent variations. In addition, embodiments of the invention are not described with reference to any particular programming language. It is appreciated that a variety of programming languages may be used to implement the present teachings as described herein, and any references to specific languages are provided for disclosure of enablement and best mode of embodiments of the invention. Embodiments of the invention are well suited to a wide variety of computer network systems over numerous topologies. Within this field, the configuration and management of large networks include storage devices and computers that are communicatively coupled to dissimilar computers and storage devices over a network, such as the Internet.

The functions, systems and methods herein described could be utilized and presented in a multitude of languages. Individual systems may be presented in one or more languages and the language may be changed with ease at any point in the process or methods described above. One of ordinary skill in the art would appreciate that there are numerous languages the system could be provided in, and embodiments of the present invention are contemplated for use with any language.

While multiple embodiments are disclosed, still other embodiments of the present invention will become apparent to those skilled in the art from this detailed description. The invention is capable of myriad modifications in various obvious aspects, all without departing from the spirit and scope of the present invention. Accordingly, the drawings and descriptions are to be regarded as illustrative in nature and not restrictive.

1. A system for providing simplified end-to-end security for computing devices in standalone, LAN, WAN or Internet architectures; said system comprising:
an email processing module, comprising computer-executable code stored in non-volatile memory,
a machine learning module, comprising computer-executable code stored in non-volatile memory,
a processor, and
a communications means,
wherein said email processing module, said machine learning module, said processor, and said communications means are operably connected and are configured to:
receive an email;
remove hypertext markup language (HTML) from said email;
remove white space, new line, carriage returns (CR) and tabs from said email;
convert all text contained in said email to lowercase characters;
compare text to relationship terms stored in a relationship term database;
tag text matching one or more of said relationship terms;
tag text comprising dates, numbers, indicators of time, measurement units, and currency symbols;
tag text comprising parts of speech;
compare text to lemmatize terms stored in a lemmatize dictionary database;
tag text matching one or more lemmatize terms;
remove non-essential punctuation from said text;
calculate and weigh term frequency in said text using term frequency inverse document frequency;
eliminate one or more terms with the lowest calculated weight; and
classify said email based on remaining tags and terms.

2. The system of claim 1, wherein the classification of said email is accomplished via a Naive Bayes classifier process.

3. The system of claim 1, wherein the system further comprises a NaïBayes Trainer module and a NaïBayes classifier module.

4. The system of claim 1, wherein the classification of said email is accomplished via a Support Vector Machines (SVM) or Support Vector Networks (SVN) classifier process.

5. The system of claim 1, wherein the system further comprises one or more of a Support Vector Machine trainer module, a Support Vector Network trainer module, a Support Vector Machine classifier module, and a Support Vector Network classifier module.

6. The system of claim 1, wherein said email processing module, said machine learning module, said processor, and said communications means are further configured to match remaining terms with categories stored in a category database.

7. The system of claim 6, wherein said email processing module, said machine learning module, said processor, and said communications means are further configured to replace one or more remaining terms with replacement tags.

8. The system of claim 7, wherein said email processing module, said machine learning module, said processor, and said communications means are further configured to move said email to a location based on said replacement tags.

9. The system of claim 6, wherein said email processing module, said machine learning module, said processor, and said communications means are further configured to replace one or more remaining terms with replacement categories.

10. The system of claim 9, wherein said email processing module, said machine learning module, said processor, and said communications means are further configured to move said email to a location based on said replacement categories.

11. A method for classifying emails, said method comprising the steps of:
receiving an email at an email processing module, comprising computer-executable code stored in non-volatile memory;
removing hypertext markup language (HTML) from said email;
removing multiple white space, and tabs from said email;
converting all text contained in said email to lowercase characters;
comparing text to relationship terms stored in a relationship term database;
tagging text matching one or more of said relationship terms;
tagging text comprising dates, numbers, indicators of time, measurement units, and currency symbols;
tagging text comprising parts of speech;
comparing text to lemmatize terms stored in a lemmatize dictionary database;
tagging text matching one or more lemmatize terms;
removing non-essential punctuation from said text;
calculating and weigh term frequency in said text using term frequency inverse document frequency;
eliminating one or more terms with the lowest calculated weight; and
classifying said email based on remaining tags and terms.

12. The method of claim 11, wherein the classification of said email is accomplished via a Naive Bayes classifier process.

13. The method of claim 11, wherein the classification of said email is accomplished via a Support Vector Machines (SVM) or Support Vector Networks (SVN) classifier process.

14. The method of claim 11, further comprising the step of matching remaining terms with categories stored in a category database.

15. The method of claim 11, further comprising the step of replacing one or more remaining terms with replacement tags.

16. The method of claim 15, further comprising the step of moving said email to a location based on said replacement tags.

17. The method of claim 11, further comprising the step of replacing one or more remaining terms with replacement categories.

18. The method of claim 17, further comprising the step of moving said email to a location based on said replacement categories.
